(19) United States
(12) Patent Application Publication
(10) Pub. No.: US 2014/0012412 A1
(43) Pub. Date: Jan. 9, 2014

(54) CODING PLATFORM FOR USE WITH TRANSACTIONS ACROSS VARIOUS MEDIUMS AND DEVICES

(71) Applicants: Bhupendra Khonalkar, Chicago, IL (US); Jeffrey Rehkemper, Chicago, IL (US)

(72) Inventors: Bhupendra Khonalkar, Chicago, IL (US); Jeffrey Rehkemper, Chicago, IL (US)

(21) Appl. No.: 13/927,564

(22) Filed: Jun. 26, 2013

Related U.S. Application Data
(60) Provisional application No. 61/666,074, filed on Jun. 29, 2012.

(51) Int. Cl. G07F 11/00

(52) U.S. Cl. CPC G07F 11/002
USPC 700/237

(57) ABSTRACT

A system with distributed transaction control and processing which utilizes coding and mobile technology electronic devices to communicate transaction control with various mediums is provided. The system has the ability to facilitate access to goods or services within and/or at an independent medium such as vending machines, kiosks and point of sale systems. The system facilitates selection and payment for goods and/or services at specific independent mediums and encodes commands relating thereto for secure transfer within the system via encryption and compression of transaction information. The system may execute transaction control with and/or without internet connectivity to facilitate delivery of user desired items and/or services without requiring cash or a credit card on hand.

### CROSS-REFERENCE TO RELATED APPLICATIONS

This application claims the benefit of U.S. provisional Application No. 61/666,074 filed Jun. 29, 2012, the disclosure of which is incorporated in its entirety by reference herein.

### TECHNICAL FIELD

The illustrative embodiments relates to a system with distributed transaction control and processing, and more specifically to utilizing codes such as quick response codes (“QR Codes”) and mobile technology to communicate transaction control with various mediums such as kiosks, vending machines, and point of sale systems to obtain and/or access a product or a service via a personal electronic device such as a mobile device.

### BACKGROUND

There are a number of systems to facilitate payment transactions to purchase goods and/or services. These systems may utilize mechanics and electronics to accept payment and distribute the desired good and/or service. Examples of these systems include online websites which accept credit card payment, a store cash register which may be configured to accept cash and credit card payments, and vending machines with may be configured to accept cash and credit card payments. As consumers increase the utilization of these systems across different mediums, security threats relating to personal privacy and potential fraud may also increase.

### SUMMARY

An autonomous item dispensary for dispensing items includes an identification signature, one or more digitally identifiable items associated with the identification signature, and a processor in communication with a code receiver and an item dispensing unit. The processor may be configured to handle a code receipt received by the code receiver to verify completion of a purchase transaction relating to one or more of the digitally identifiable items. The processor may also direct the item dispensing unit to deliver one or more purchased items identified by the code receipt.

The code receiver may receive the code receipt from a user electronic device. The user electronic device may receive the code receipt from a remote server. The code receiver may capture an image of the code receipt. The code receiver may capture an image of the code receipt displayed on the user electronic device. The code receipt may include data including the identification signature and a purchase time stamp encrypted with a variable encryption cipher key. The code may be configured to decrypt the variable encryption cipher key and obtain a current time stamp for comparing with the purchase time stamp. The code receipt may also include operating instructions to facilitate the delivery of the one or more purchased items identified by the code receipt. The processor is may also be configured to send a record of the purchase transactions relating to the one or more digitally identifiable items to a remote server. The autonomous item dispensary may include a display configured to display information relating to the digitally identifiable items. The information may prompt a user to interact with the autonomous item dispensary. The autonomous item dispensary may include a sensor configured to capture a user interaction with the autonomous item dispensary.

A computer-implemented method includes electronically receiving a code receipt which includes verification of a purchase transaction and identification of a digitally identifiable item associated with an autonomous item dispensary identification signature. The method further includes validating the code receipt via an autonomous item dispensary and dispensing the digitally identifiable item from the autonomous item dispensary. The method may also include capturing an image of the code receipt via an autonomous item dispensary sensor. The code receipt may be captured from a user device display.

A computer readable storage medium storing instructions that, when executed by a processor of an autonomous item dispensary, causes the processor to perform a method. The method includes electronically receiving a code receipt including verification of a purchase transaction and identification of a digitally identifiable item associated with an autonomous item dispensary identification signature. The method also includes validating the code receipt via the autonomous item dispensary and dispensing the digitally identifiable item from the autonomous item dispensary. An image of the code receipt may be captured by an autonomous item dispensary sensor. The code receipt may be captured from a user electronic device display.

### BRIEF DESCRIPTION OF THE DRAWINGS

A fuller understanding of the foregoing may be had by reference to the accompanying drawings, wherein:

FIG. 1 is a block diagram of an illustrative transaction system;

FIG. 2 is a block diagram of an example of an independent medium for use with the transaction system from FIG. 1;

FIG. 3 is a block diagram of an example of an electronic device for use with the transaction system from FIG. 1;

FIG. 4 is a flow chart of an illustrative start-up process for an independent medium;

FIG. 5 is a flow chart illustrating steps included in an operational example of the transaction system to execute a task to obtain an item;

FIG. 6 is a flow chart illustrating steps in an exemplary encoding process utilized by the transaction system;

FIG. 7 is a flow chart illustrating a decoding process utilized by the transaction system;

FIG. 8 is a block diagram of another illustrative transaction system;

FIG. 9 is a block diagram of an example of an independent medium for use with the transaction system from FIG. 8;

FIG. 10 is a block diagram of an example of an electronic device for use with the transaction system from FIG. 8;

FIG. 11 is a flow chart of an illustrative start-up process for an independent medium;

FIG. 12 is a flow chart illustrating steps included in an operational example of the transaction system to execute a task to obtain an item;

FIG. 13 is a flow chart illustrating steps in an exemplary encoding process utilized by the transaction system;

FIG. 14 is a flow chart illustrating an illustrative decoding process utilized by the transaction system;

FIG. 15 is a block diagram of another illustrative transaction system;

FIG. 16 is a block diagram of an example of an electronic device for use with the transaction system from FIG. 15;

FIG. 17 is a block diagram of an example of an independent medium for use with the transaction system from FIG. 15;

FIG. 18 is a flow chart of an illustrative start-up process for an independent medium;

FIG. 19 is a flow chart illustrating steps included in an operational example of the transaction system to execute a task to obtain an item;

FIG. 20 is a flow chart illustrating steps in an exemplary encoding process utilized by the transaction system;

FIG. 21 is a flow chart illustrating an example of a decoding process utilized by the transaction system; and

FIG. 22 is a flow chart illustrating steps included in an operation example of the transaction system to execute a task to obtain an item.

### DETAILED DESCRIPTION

While the invention is susceptible to embodiments in many different forms, there are shown in the drawings and will be described herein, in detail, the preferred embodiments of the present invention. It should be understood, however, that the present disclosure is to be considered an exemplification of the principles of the invention and is not intended to limit the spirit or scope of the invention or the embodiments illustrated.

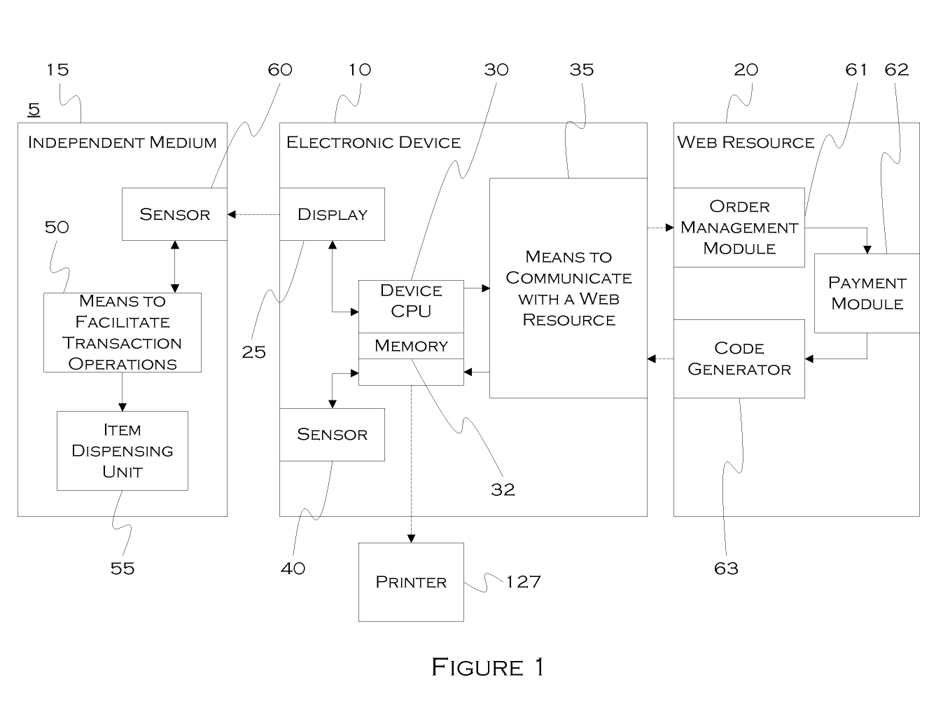

Referring now to FIG. 1, there is illustrated a transaction system 5 in accordance with one illustrative embodiment. The transaction system 5 utilizes a personal electronic device 10 to interact with an independent medium 15 and a web resource 20 to facilitate access to items such as goods or services included within and/or related to the independent medium 15. Software included in the transaction system 5 encodes a command or commands into a code to create a set of instructions for the independent medium 15 to perform a desired task via interaction with the electronic device 10. In this embodiment, the code with commands and utilized by the transaction system 5 is a quick response code (“QR Code”) described further herein.

Examples of a personal electronic device 10 include a smart phone or other similar mobile device. An illustrative electronic device 10 may include a display 25 capable of displaying a code such as a QR Code, a device computer processing unit (“CPU”) 30 with a memory 32, capability to communicate with a web resource 35, a sensor 40 such as a camera, and a power source (not shown). Examples of an independent medium 15 include, but are not limited to, vending machines, point of sale systems (“POS Systems”), and kiosks. An exemplary independent medium 15 may include capability to facilitate transaction operations 50 in communication with a product dispensing unit 55, a power source (not shown), and a sensor 60. An illustrative web resource 20 may include an order management module 61, a payment module 62 and a code generator 63 which may create a code receipt including compressed and encrypted data representing commands to direct independent medium 15 actions (described further below).

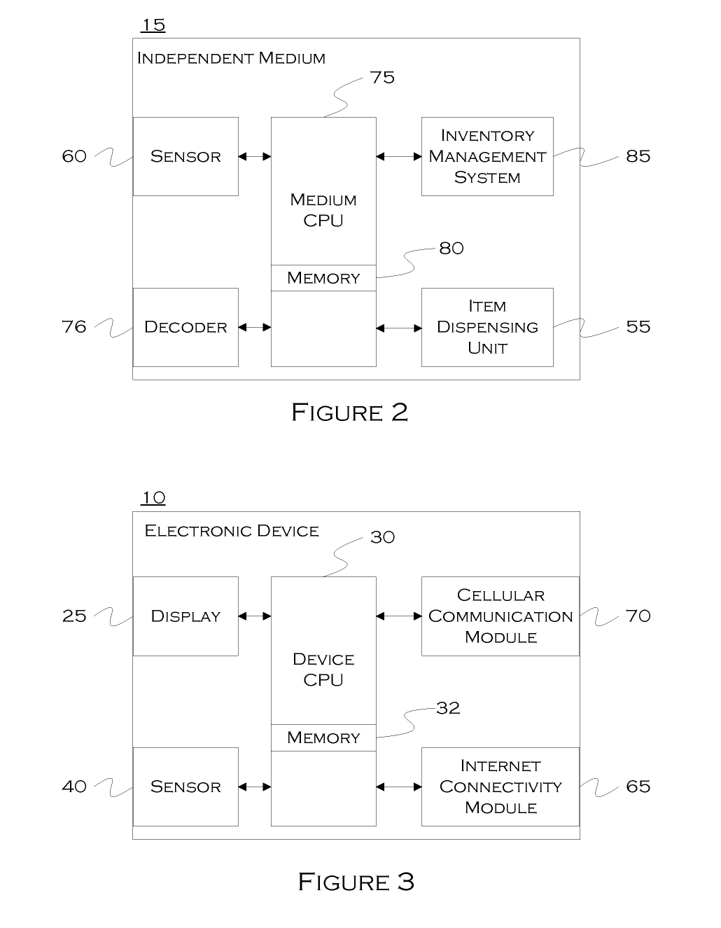

FIG. 2 provides an example of a configuration for the independent medium 15. In this illustrative example, the capability to facilitate transaction operations 50 includes a POS CPU 75 with a memory 80, a decoder 76, and an inventory management system 85.

FIG. 3 provides an example of a configuration for the electronic device 10 where the means to communicate with a web resource 35 includes an internet connectivity module 65 and/or a cellular communication module (“CCM”) 70.

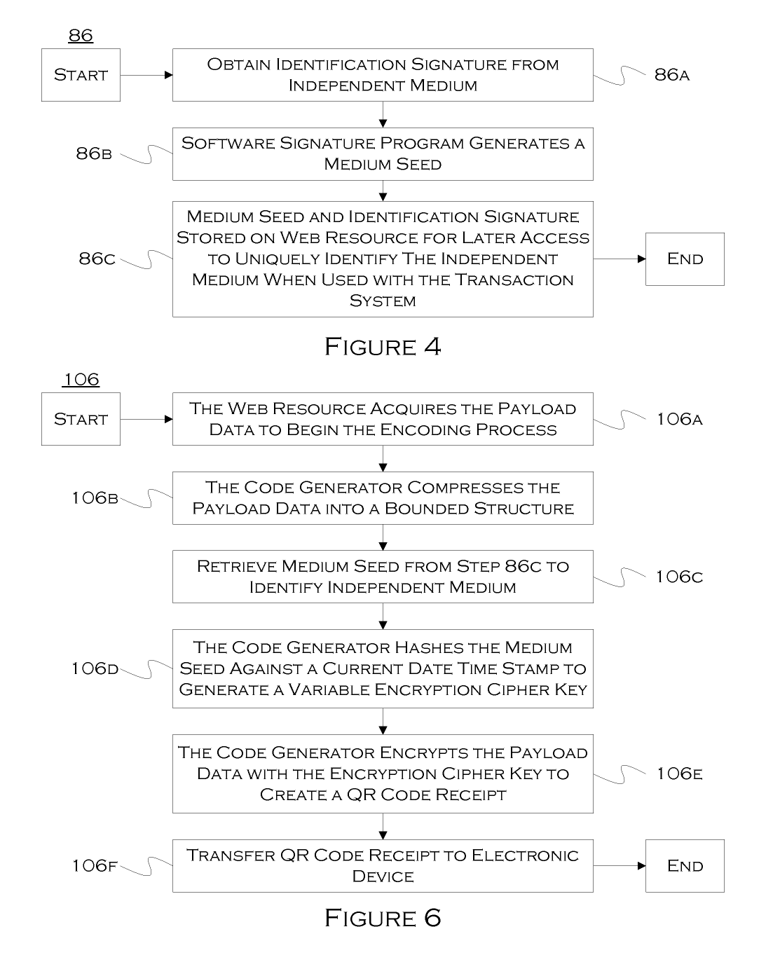

FIG. 4 shows an initial setup process 86 for the independent medium 15 where in step 86a an identification signature is obtained from the independent medium 15. In step 86b, a software signature program generates a randomized medium seed using the identification signature encoded on and specific to the independent medium 15. The medium seed is then stored on the web resource 20 in step 86c, such as a central server. The medium seed thereafter is usable to uniquely identify the independent medium 15 during the transactions and operations described below.

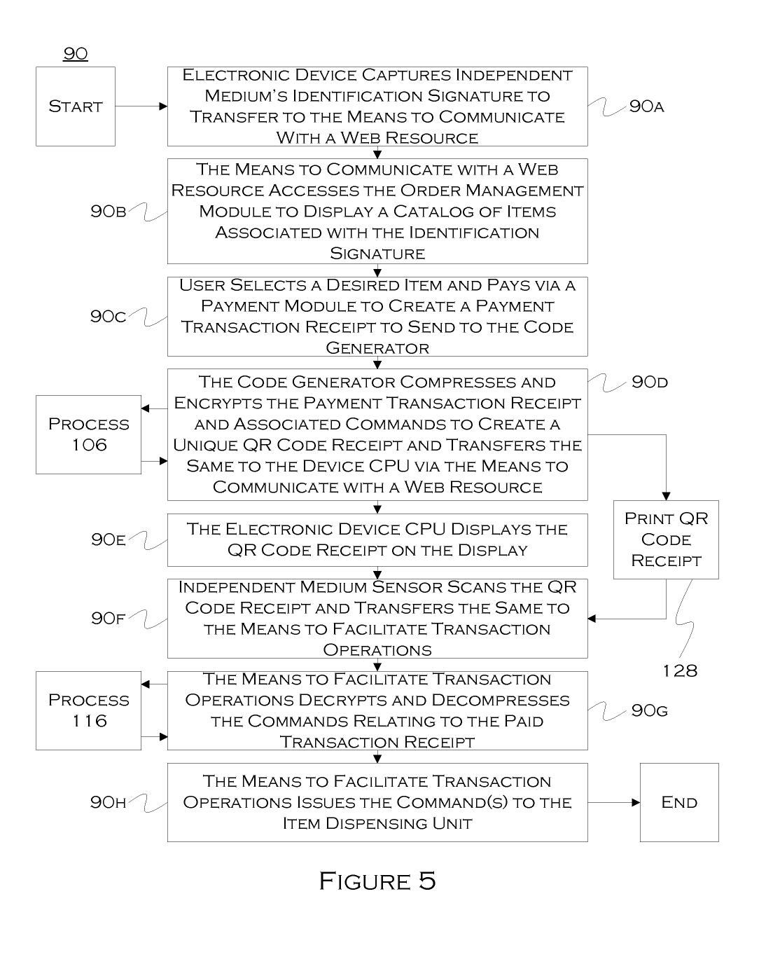

Referring now additionally to FIG. 5 through 7, there are provided flow charts showing an example of operation 90 where the transaction system 5 utilizes the electronic device 10 to access the web resource 20 and interact with the independent medium 15 to obtain a desired item. In operation 90, the independent medium 15 does not require internet connectivity and includes the identification signature in a position accessible by the electronic device 10 such as on a display or a sticker fixed thereto.

The identification signature is specific to the particular independent medium 15 and includes information to direct the electronic device 10 to the web resource 20 to view items available for purchase. The electronic device 10 captures the identification signature via the sensor 40, or via text input in accordance with the identification signature, which is then sent to the device CPU 30 to distribute to the means to communicate with a web resource 35 as shown in step 90a. Based on the information included in the identification code, the means to communicate with a web resource 35 accesses an associated web resource, such as a website which includes a catalog of items available for purchase from the independent medium 15 as shown in step 90b.

Software on the electronic device and website may provide processing capability to execute an operating system, run various applications, and/or provide processing for one or more of the transaction techniques described herein. The applications may manage user authentication, customer orders, payments, user preferences, and generate and encrypt commands in a QR Code format to utilize with the transaction system 5. Additionally, in another embodiment described below, the electronic device may access a cellular resource via the cellular communication module 70. In step 90c, a user selects the desired item from the catalog and makes payment via the electronic device 10 to create a paid transaction receipt. Various payment means may be utilized to facilitate payment via a user account. For example, a user account for use with the transaction systems described herein may be linked to a user's credit card, bank account, or an online account containing a user's money. Software in the website is configured to compress and encrypt the paid transaction receipt to generate a new and unique order receipt code, which includes commands for the independent medium 15 in step 90d and now additionally referring to an encoding process 106 in FIG. 6.

As mentioned, the type of order receipt code utilized in this embodiment is a QR Code receipt. In step 106a, the web resource 20 acquires the paid transaction receipt and data and commands associated therewith to begin the encoding process. This data and commands are referred to as payload data and may include the identification signature of the destination independent medium 15, a date time stamp, a command sequence number, and the commands, sub commands and auxiliary data for execution on independent medium 15. In step 106b, the code generator 63 compresses the payload data into a bounded structure where each element of the payload data is mapped into fixed length data and then scrambled using a predefined bit boundary compression scrambling algorithm. In step 106c, the medium seed saved in step 86c is now retrieved based on the according independent medium 15.

The code generator 63 then hashes the medium seed against the current date time stamp using a hashing function to generate a variable encryption cipher key in step 106d. In step 106e the payload data is then encrypted using the encryption cipher key for encoding by the code generator 63 to create a QR Code receipt which in step 106f is transferred to the device CPU 30 via the means to communicate with a web resource 35 at step 90d. The electronic device 10 display 25 displays the QR Code receipt for positioning in front of the independent medium 15 sensor 60 as shown in step 90e. The sensor 60 captures the QR Code receipt as a digital image.

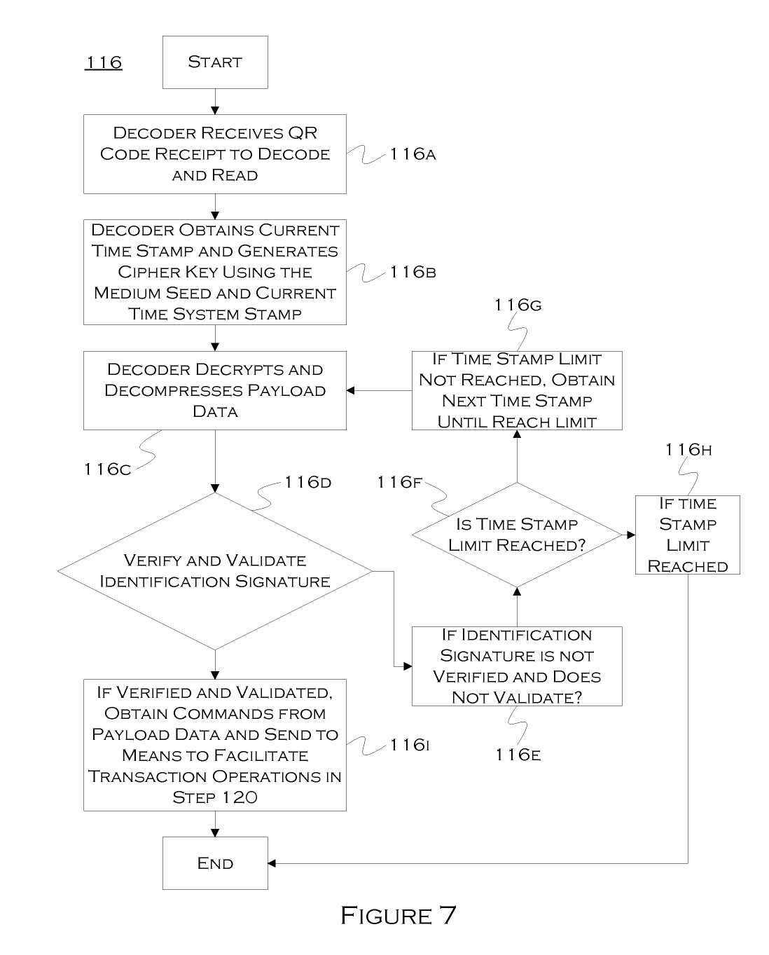

Software, such as optical character recognition software is used to input data from the QR Code receipt and is transferred to the means to facilitate transaction operations 50 as shown in step 90f. In step 90g the means to facilitate transaction operations 50 executes software modules to decrypt and decompress the QR Code receipt to access the commands relating to the paid transaction receipt further described in a decoding process 116 in FIG. 7. Process 116 runs on the decoder 76 within the independent medium 15. In step 116a the decoder 76 receives the QR code receipt generated in process 106 for decoding. In step 116b the decoder 76 obtains a current time system stamp and generates a cipher key using the medium seed generated in step 86b and the current time system stamp. In step 116c the decoder 76 then attempts to decrypt and decompress the payload data as cipher text included in the QR code receipt to verify whether the correct identification signature is embedded therein for the according independent medium 15. The payload data is decrypted using the variable encryption cipher key and decompressed using the predefined bit boundary compression scrambling algorithm from process 106. In step 116d the decoded payload data is verified using a checksum and the identification signature embedded in the header of the payload data. If verified in step 116d, in step 116i the medium CPU obtains the commands from the payload data and sends the commands to the means to facilitate transaction operations 50 at step 120.

If step 116d does not verify and validate the identification signature, the decoder 76 obtains another current time system stamp generated via a fixed offset. This time stamp is then used to repeat steps 116c and 116d until either the time stamp limit is reached or the identification signature is verified as shown in steps 116e, 116f, and 116g. Alternatively, it should be understood that it is within the scope of the invention for the transaction system 5 to operate without utilizing a time stamp when creating the purchased item receipt and during decryption and decompression. The utilization of a time stamp adds additional security if desired and may also be used to create an expiration time for the QR Code receipt. Of course, other suitable security measures can be utilized as well, if desired.

If no identification signature is verified then the decoding fails and an error feedback is generated for the user in step 116h where the means to facilitate transaction operations will abort further processing. With a successful validation and decryption, in step 90h the command or commands are then used by the independent medium 15 to direct the item dispensing unit 55 to dispense an item in accordance thereto. For example, where the independent medium 15 is a vending machine, the above sequence of events provides an option for a user to purchase a can of soda utilizing a mobile device without the need for cash or a credit card on hand and where the independent medium lacks internet connectivity.

Additionally, where the electronic device 10 is in communication with a printer 127, in step 128 the device CPU 30 may transfer the QR Code receipt to the printer 127 to output a printed copy of the QR Code receipt for a user to manually position in front of the independent medium 15 sensor 60. Further, where the electronic device 10 is a personal computer, a user may execute the above-mentioned steps to obtain a QR Code receipt, but instead of utilizing the display as with a smart phone, the user may print a QR Code receipt at their home as shown in step 128, and then utilize the printed QR Code receipt at the according independent medium.

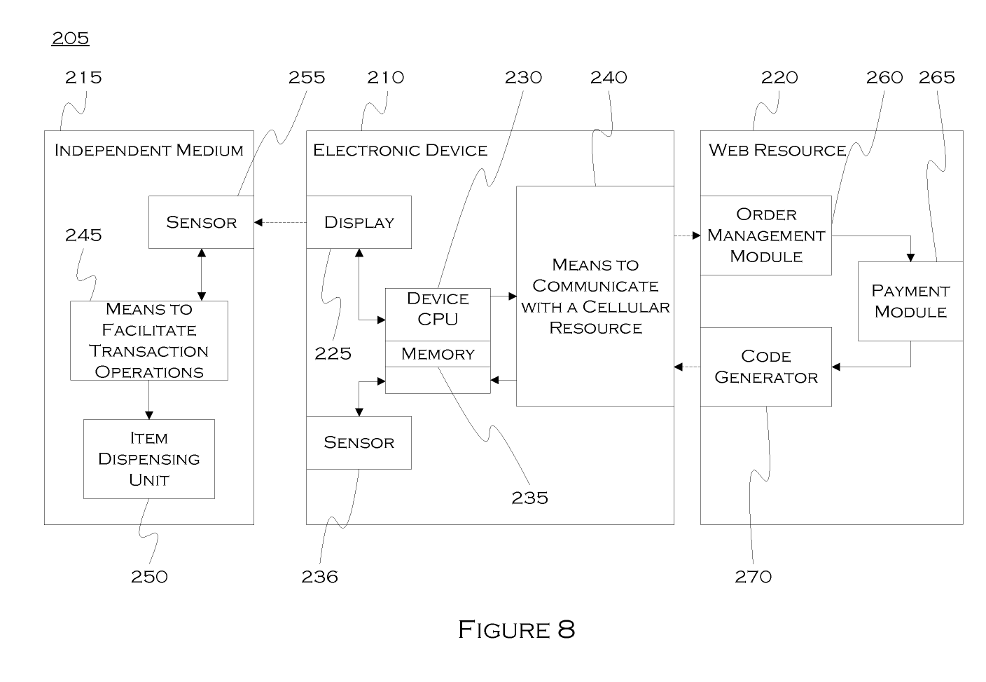

Referring now to FIG. 8, there is illustrated another transaction system 205. The transaction system 205 utilizes a personal electronic device 210 to interact with an independent medium 215 and a cellular resource 220 via a cellular connection to facilitate a means to obtain access to items such as goods or services included within and/or related to the independent medium 215. One example of a cellular connection includes utilizing a 1-800 telephone number to facilitate interaction with the cellular resource 220, such as an automated call center where the automated call center uses software to encode a command or commands into a code to create a set of commands for the independent medium 215 to perform a desired task via interaction with the electronic device 210 as described herein. In this embodiment, the code with commands and utilized by the transaction system 205 is a QR Code.

Examples of a personal electronic device 210 include a mobile phone and in this embodiment, the electronic device 210 does not require internet connectivity. The electronic device 210 includes a display 225 capable of displaying a code such as a QR Code, a device CPU 230 with a memory 235, a sensor 236, a means to communicate with a cellular resource 240, and a power source (not shown). Examples of an independent medium 215 include vending machines, POS systems, and kiosks. The independent medium 215 includes a means to facilitate transaction operations 245 in communication with an item dispensing unit 250 a sensor 255 and a power source (not shown). The cellular resource 220 includes an order management module 260, a payment module 265 and a code generator 270 to create a QR Code receipt which includes compressed and encrypted data representing commands to direct independent medium 215 actions (described further below).

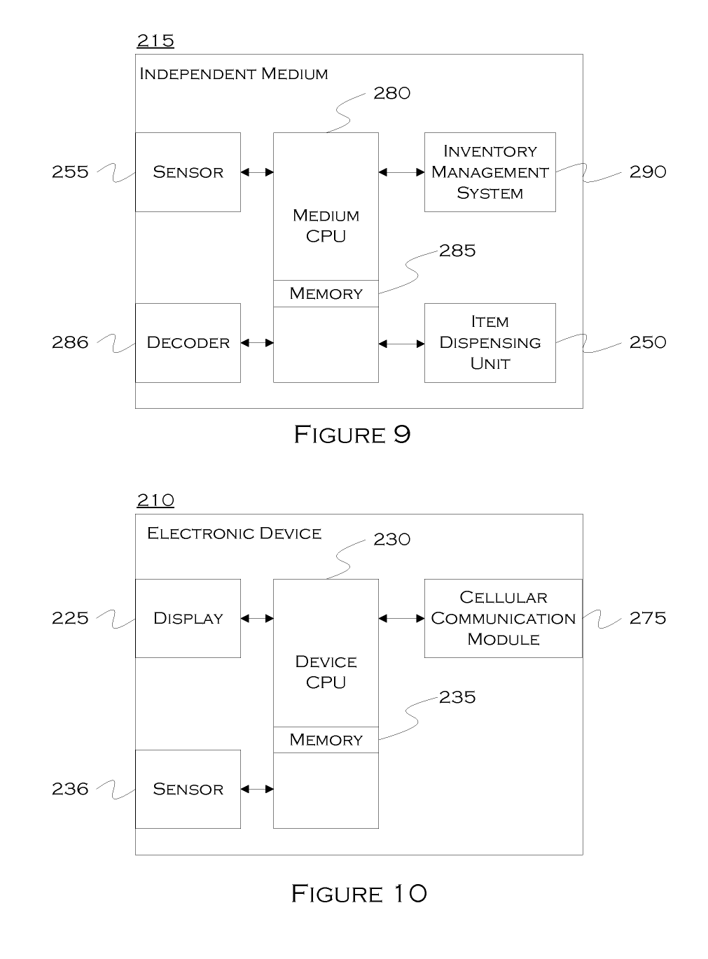

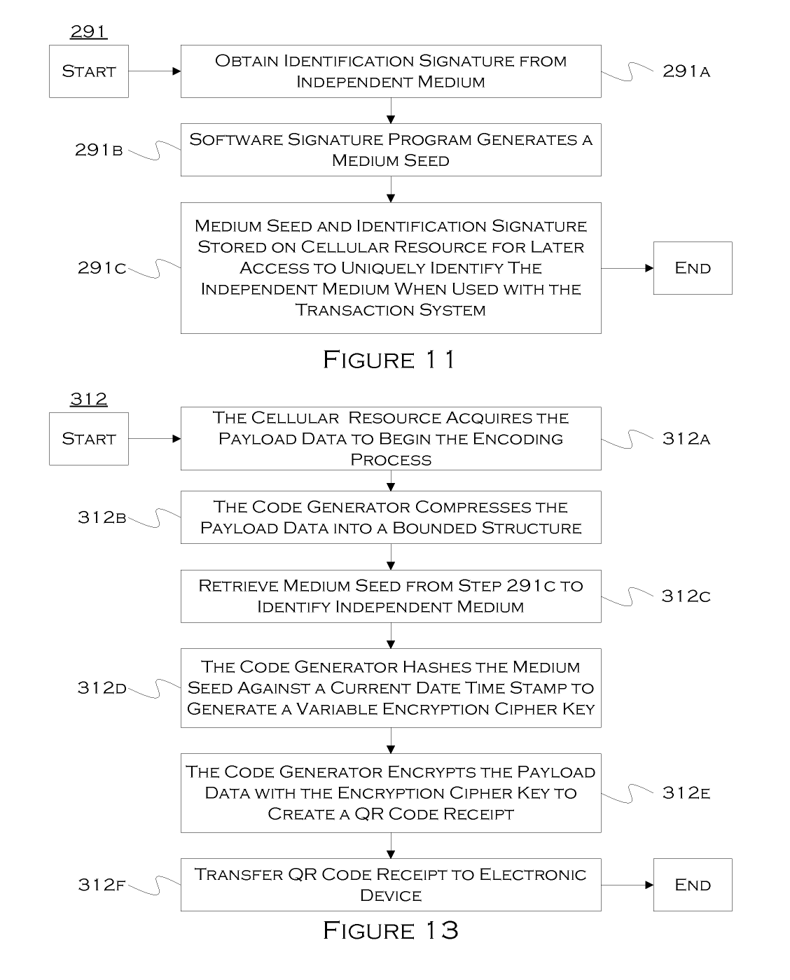

FIG. 9 provides an example of a configuration for the independent medium 215 where the means to facilitate transaction operations 245 includes a medium CPU 280 with a memory 285, a decoder 286, and an inventory management system 290. FIG. 10 provides an example of a configuration for the electronic device 210, where the means to communicate with a cellular resource includes a CCM 275. FIG. 11 shows an initial setup process 291 of independent medium 215 where in step 291 a an identification signature is obtained from the independent medium 215 and in step 291b a software signature program generates a randomized medium seed using the identification signature encoded on and specific to the independent medium 215. The medium seed is then stored on the cellular resource 220 in step 291c. The medium seed thereafter is usable to uniquely identify the independent medium 215 during the transactions and operations described below.

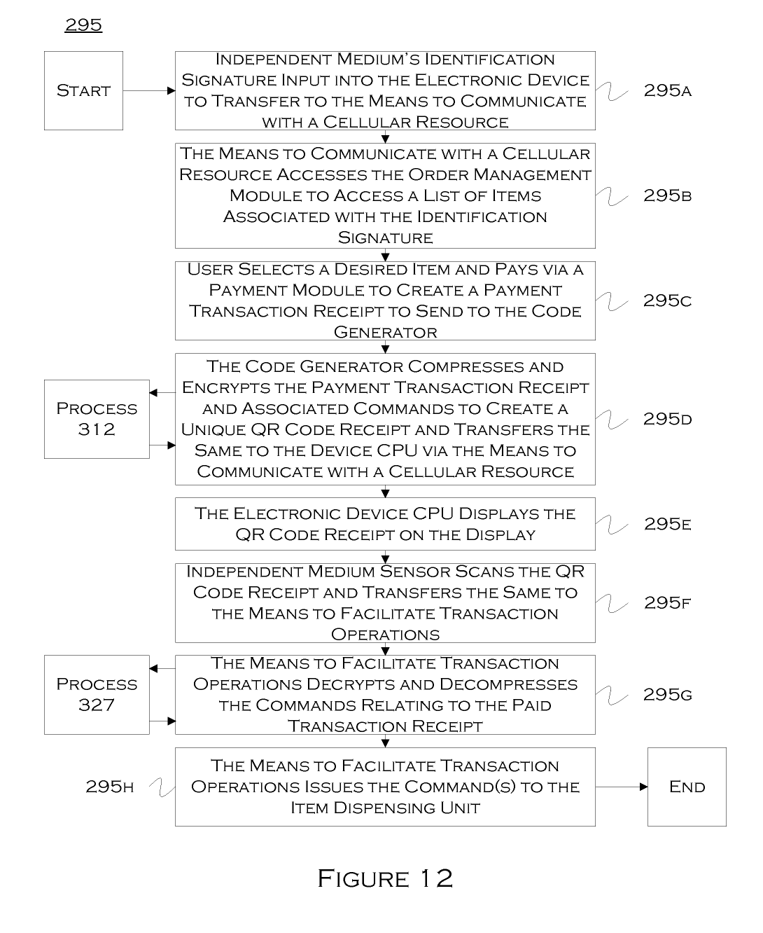

Referring now additionally to FIGS. 12 through 14, there are provided flow charts showing an example of operation where the transaction system 205 utilizes the electronic device 210 to access the cellular resource 220 and interact with the independent medium 215 to obtain a desired item. In this example, the independent medium 215 includes the identification signature in a position accessible by the electronic device 210 such as on a display or a sticker fixed thereto. The identification signature is specific to the particular independent medium 215 and includes information to direct the electronic device 215 to the cellular resource 220 to obtain a list of items available for purchase. One example of a form the identification signature may take is as a 1-800 number specific to the independent medium 215.

In this example, the electronic device 210 places a call via the 1-800 number to access the order management system 205 of the cellular resource 220 to interact with an automated call center to obtain a list of items available for purchase from the independent medium 215 as shown in steps 295a and 295b, respectively. Software within the cellular resource 220 may provide processing capability to run various applications and/or provide processing for one or more of the transaction techniques described herein. The applications may manage user authentication, customer orders, payments, user preference tracking, and to generate and encrypt commands in a QR Code format to utilize with the independent medium 215. When in communication with the cellular resource 220, in step 295c the user selects a desired item via an audio catalog and submits payment via the electronic device 210 with verbal or keystroke inputs to create a paid transaction receipt.

Software within the cellular resource 220 is configured to compress and encrypt the paid transaction receipt to generate a new and unique order receipt code which includes commands for the independent medium 215 as shown in step 295d. As mentioned, the type of order receipt code utilized in this embodiment is a QR Code receipt. As shown in an encoding process 312 step 312a, the cellular resource 220 acquires the paid transaction receipt and data associated therewith to begin the encoding process. This data is referred to as the payload data and includes the identification signature of the destination independent medium 215, a date time stamp, a command sequence number, and the commands, sub commands and auxiliary data for execution on independent medium 215. In step 312b, the code generator 270 compresses the payload data into a bounded structure where each element of the payload data is mapped into fixed length data and then scrambled using a predefined bit boundary compression scrambling algorithm.

In step 312c, the medium seed saved in step 291c is now retrieved based on the according independent medium 215. The code generator 270 then hashes the medium seed against the current date time stamp using a hashing function to generate a variable encryption cipher key in step 312d. In step 312e the payload data is then encrypted using the encryption cipher key for encoding by the code generator 270 to create a QR code receipt which in step 312f is transferred to the device CPU 230 via the means to communicate with a cellular resource 240, for example in the form of a SMS message.

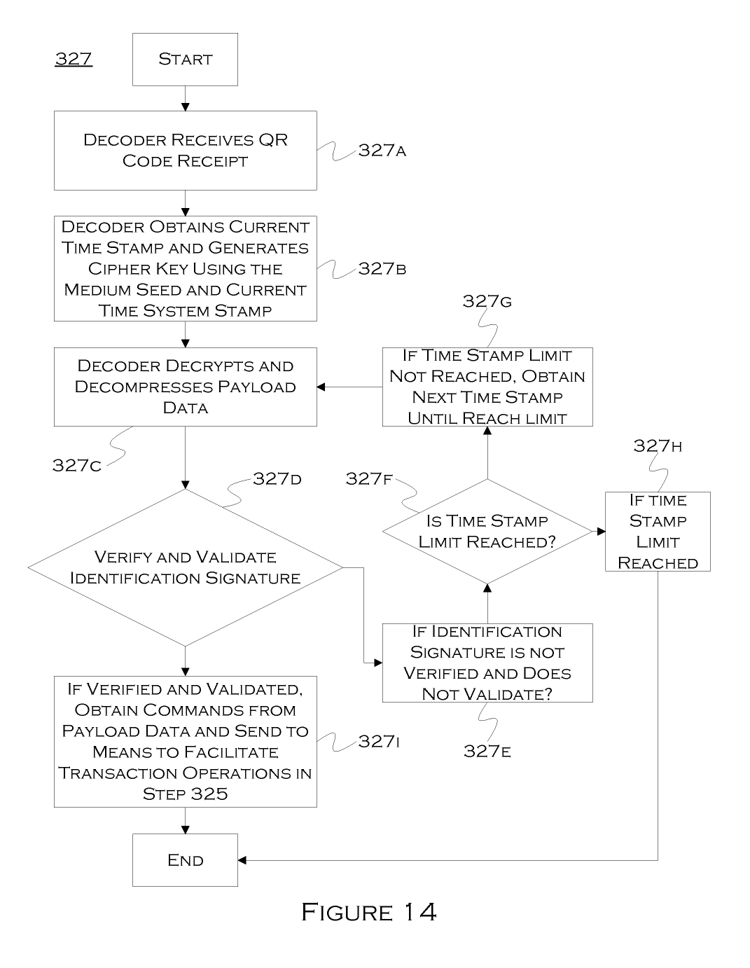

Now again referring to FIG. 12 step 295e, the electronic device 210 display 225 displays the QR Code receipt for positioning in front of the independent medium 215 sensor 255. In step 295f, the sensor 255 captures the QR Code receipt as a digital image. Software, such as optical character recognition software is used to input data from the QR Code receipt and is transferred to the means to facilitate transaction operations 245. In step 295g, the means to facilitate transaction operations 245 executes software modules to decrypt and decompress the QR Code receipt to access the commands relating to the paid transaction receipt further described in a decoding process 327 in FIG. 14. This process runs on the decoder 286 within the independent medium 215.

In step 327a the decoder 286 receives the QR Code receipt generated in process 312 for decoding. In step 327b the decoder 286 obtains a current time system stamp and generates a cipher key using the medium seed generated in process 291 and the current time system stamp. In step 327c the decoder 286 then attempts to decrypt and decompress the payload data as cipher text included in the QR Code receipt to verify whether the correct identification signature is embedded therein for the according independent medium 215. The payload data is decrypted using the variable encryption cipher key and decompressed using the predefined bit boundary compression scrambling algorithm from process 312. In step 327d the decoded payload data is verified using a checksum and the identification signature embedded in the header of the payload data. If verified in step 327d, in step 327i the medium CPU 280 obtains the commands from the payload data and sends the commands to the means to facilitate transaction operations 245 at step 295g in FIG. 12.

If step 327d does not verify and validate the identification signature, the decoder 286 obtains another current time system stamp generated via a fixed offset. This time stamp is then used to repeat steps 327c and 327d until either the time stamp limit is reached or the identification signature is verified as shown in steps 327e, 327f, and 327g. Alternatively, it should be understood that it is within the scope of the invention for the transaction system 205 to operate without utilizing a time stamp when creating the purchase item receipt and during decryption and decompression. The utilization of a time stamp adds additional security if desired and may also be used to create an expiration time for the QR Code receipt.

If no identification signature is verified then the decoding fails and an error feedback is generated for the user in step 327h where the means to facilitate transaction operations will abort further processing. With a successful validation and decryption, in step 330, the command or commands are then used by the independent medium 215 to direct the item dispensing unit 250 to dispense an item in accordance thereto. For example, where the independent medium 215 is a vending machine, the above sequence of events provides an option for a user to purchase a can of soda utilizing a mobile device without internet connectivity and without the need for cash or a credit card on hand.

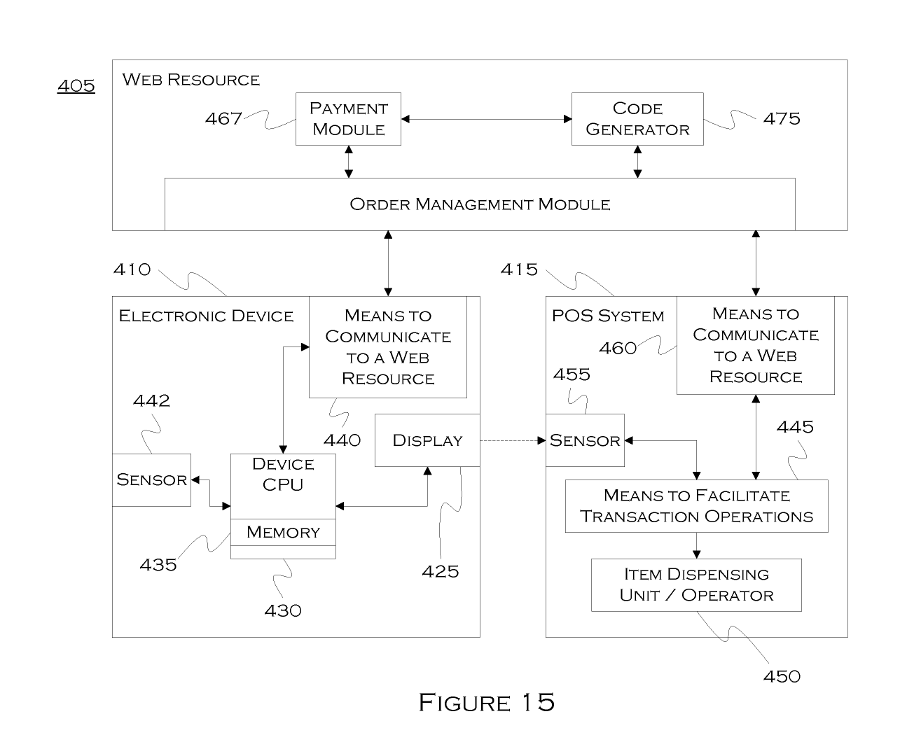

Referring now to FIG. 15, there is illustrated a transaction system 405. The transaction system 405 utilizes a personal electronic device 410 to interact with an independent medium and a web resource 420 to facilitate a means to obtain access to items such as goods or services from the independent medium where the independent medium is a point of sale system (“POS system”) 415. In this embodiment, a user places and pays for an item prior to arrival at the desired POS system 415. Software included in the transaction system 405 encodes a command or commands into a code to create a set of instructions for the independent medium 415 to perform a desired task via interaction with the electronic device 410. For example, a user may order a coffee from a coffee shop near their place of work while in transit on a commute such that the coffee is ready upon the user's arrival. In this embodiment, the code with instructions and utilized by the transaction system 405 is a QR Code and both the electronic device 410 and the POS system 415 have internet connectivity.

The electronic device includes a display 425 capable of displaying a code such as a QR Code, a device CPU 430 with a memory 435, a means to communicate with a web resource 440, a sensor 442, and a power source (not shown). The POS system 415 includes a means to facilitate transaction operations 445 in communication with an item delivery unit 450, a sensor 455, a means to communicate with a web resource 460, and a power source (not shown). The web resource 420 includes an order management module 465, a payment module 467, and a code generator 475 which creates a code receipt which includes compressed and encrypted data representing commands to direct POS system 415 actions (described further below).

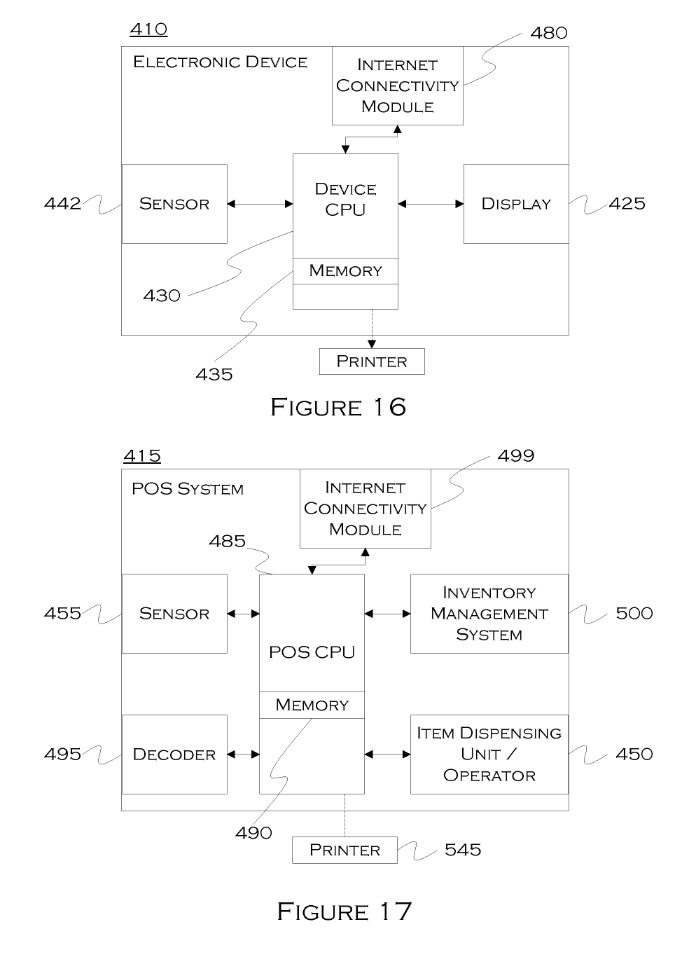

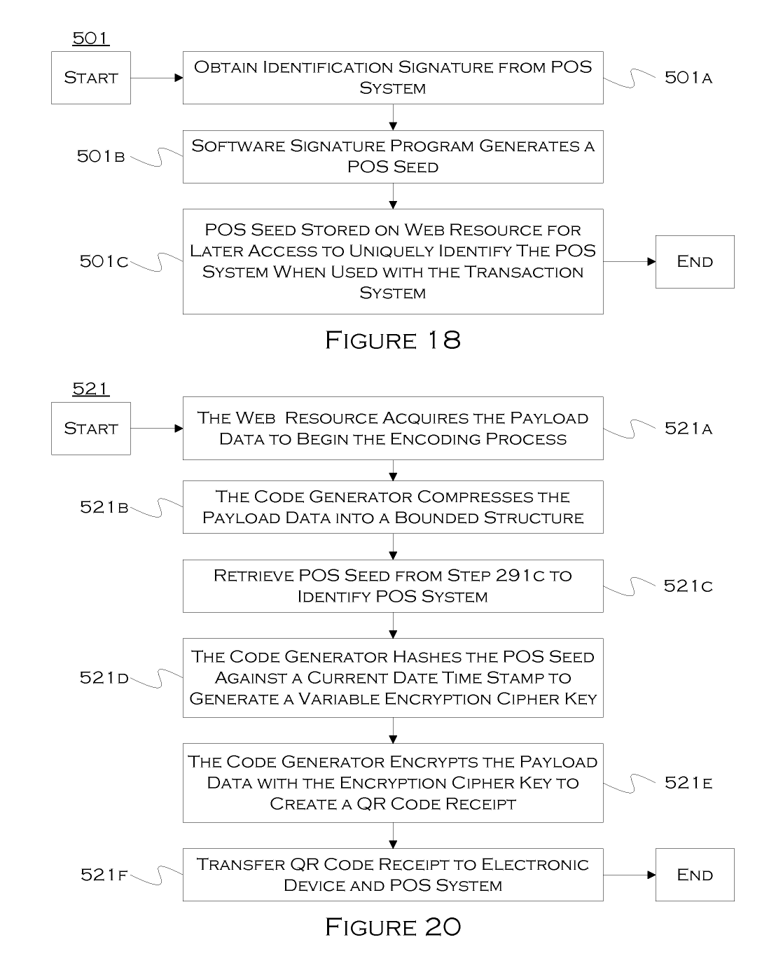

FIG. 16 provides an example of a configuration for the electronic device 410 where the means to communicate with the web resource 420 includes an internet connectivity module 480. FIG. 17 provides an example of a configuration for the POS system 415 where the means to facilitate transaction operations 445 includes a POS CPU 485 with a memory 490, a decoder 495, and an inventory management system 500 and the means to communicate with a web resource 460 includes an internet connectivity module 499. FIG. 18 shows an initial setup process 501 of POS system 415 where in step 501a an identification signature is obtained from the POS system 415 and in step 501b a software signature program generates a randomized POS seed using the identification signature encoded on and specific to the POS system 415. The POS seed and is then stored on the web resource 420, such as in a central server in step 501c. The POS seed thereafter is used to uniquely identify the POS system 415 during the transactions and operations described below.

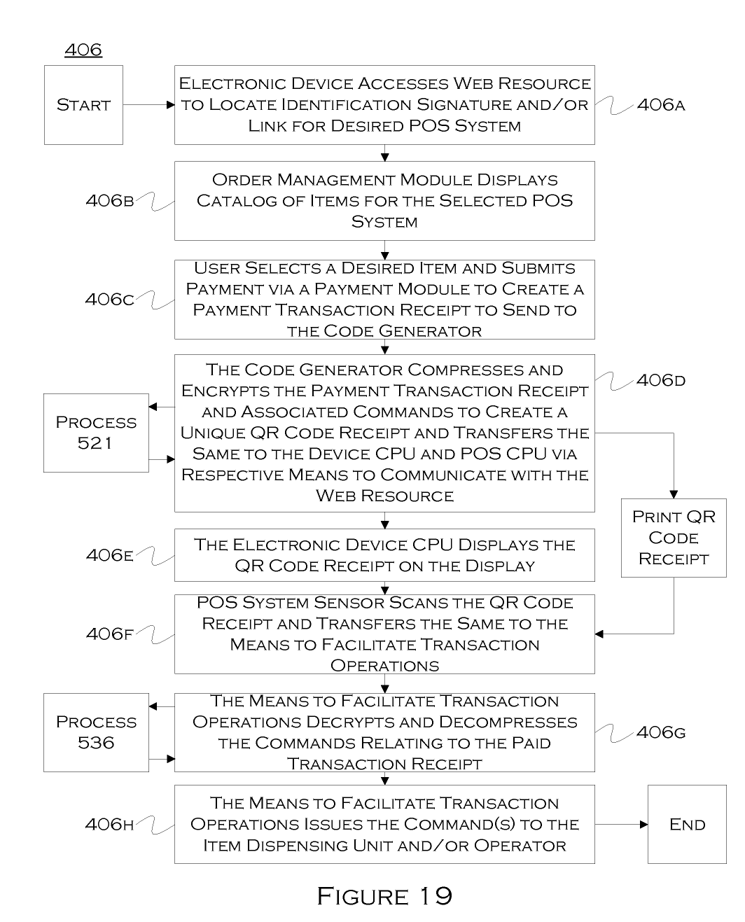

Referring now additionally to FIGS. 19 through 21, there are provided flow charts showing an example of the transaction system 405 operation 406 where the electronic device 410 and POS system 415 communicate with the web resource 420 to obtain a desired item. In operation 406, the electronic device 410 accesses the web resource 420 to locate the identification signature, which may be in the form of a hyperlink, for the desired POS system 415 in step 406a. Once located, the order management module 465 displays a catalog of items for the selected POS system 415 in step 406b. In step 406c, a user selects the desired item from the catalog and makes payment via the electronic device 410 to create a paid transaction receipt.

Software in the web resource is configured to compress and encrypt the paid transaction receipt to generate a new and unique order receipt code which includes commands for the POS system 415 in step 406d and now further referring to an encoding process 521 in FIG. 20. As mentioned, the type of order receipt code utilized in this embodiment is a QR Code receipt. As shown in step 521 a, the web resource 420 acquires the paid transaction receipt and data associated therewith to begin the encoding process 521. This data is referred to as the payload data and includes the identification signature of the destination POS system 415, a date time stamp, a command sequence number, and the commands, sub commands and auxiliary data for execution on POS system 415. In step 521b, the code generator 475 compresses the payload data into a bounded structure where each element of the payload data is mapped into fixed length data and then scrambled using a predefined bit boundary compression scrambling algorithm.

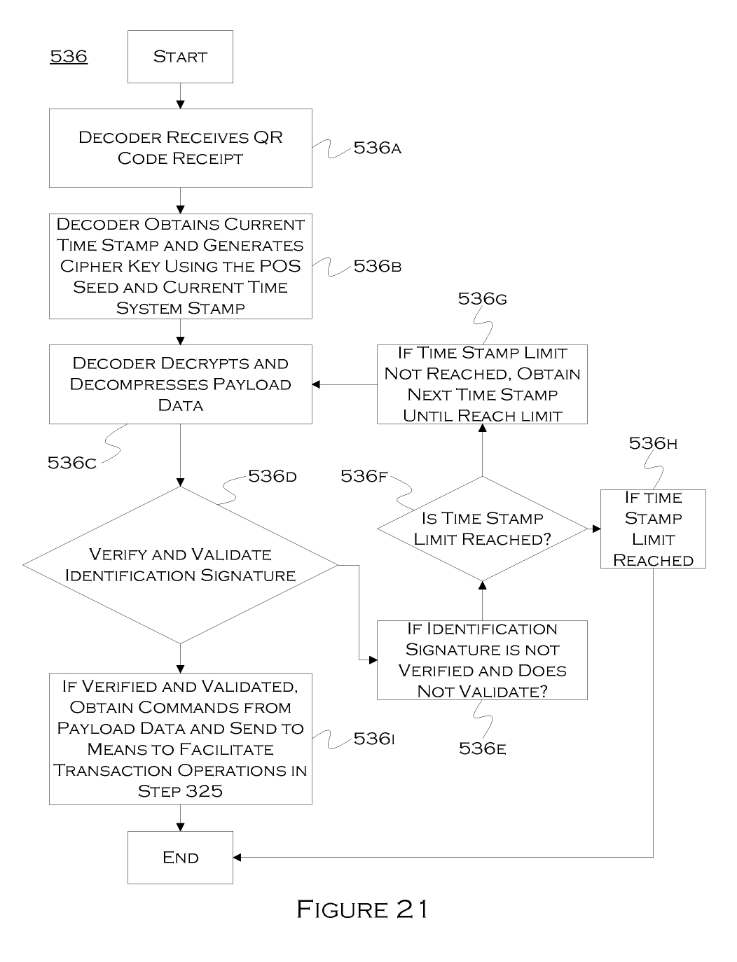

In step 521c, the POS seed saved in step 501c is now retrieved based on the according POS system 415. The code generator 475 then hashes the POS seed against the current date time stamp using a hashing function to generate a variable encryption cipher key in step 521 d. In step 521 e the payload data is then encrypted using the encryption cipher key for encoding by the code generator 475 to create a QR Code receipt which in step 521f is transferred to the device CPU 430 and transferred to the POS system 415 where the POS CPU 485 may trigger notice to the POS system 415 operator and/or item dispensing unit 450. The notice may include an estimated time of user arrival to facilitate efficient preparation of the desired item. Where a POS system operator is present, such as in this coffee shop example, the command or commands are then used by the POS system 415 to direct the item delivery unit or operator to print, display, or store the QR Code receipt. When the user arrives at the POS system 415, the QR Code receipt is retrieved for the display 425 to position in front of the sensor 455 on the POS system 415 in step 406e. The sensor 455 captures the QR Code receipt as a digital image. Software, such as optical character recognition software is used to input data from the QR Code receipt and is transferred to the means to facilitate transaction operations 460 in step 406f. In step 406g, the means to facilitate transaction operations 460 executes software modules to decrypt and decompress the QR Code receipt to access the commands relating to the paid transaction receipt as further described in a decoding process 536 in FIG. 21. This process runs on the decoder 495 within the POS system 415.

In step 536a the decoder 495 receives the QR code receipt generated in process 521 for decoding. In step 536b the decoder 495 then obtains a current time system stamp and generates a cipher key using the POS seed generated in process 501 step 501b and the current time system stamp. In step 536c the decoder 495 then attempts to decrypt the payload data as cipher text included in the QR code receipt to verify whether the correct identification signature is embedded therein for the according POS system 415. The payload data is decrypted using the variable encryption cipher key and decompressed using the predefined bit boundary compression scrambling algorithm from process 501. In step 536d the decoded payload data is verified using a checksum and the identification signature embedded in the header of the payload data. If verified in step 536d, in step 536i the POS CPU obtains the commands from the payload data and sends the commands to the means to facilitate transaction operations 445 at step 406g.

If step 536d does not verify and validate the identification signature, the decoder 495 obtains another current time system stamp generated via a fixed offset. This time stamp is then used to repeat steps 536c and 536d until either the time stamp limit is reached or the identification signature is verified as shown in steps 536e, 536f, and 536g. Alternatively, it should be understood that it is within the scope of the invention for the transaction system 405 to operate without utilizing a time stamp when creating the purchase item receipt and during decryption and decompression. The utilization of a time stamp adds additional security if desired and may also be used to create an expiration time for the QR Code receipt.

If no identification signature is verified then the decoding fails and an error feedback is generated for the user in step 536h where the means to facilitate transaction operations will abort further processing.

With a successful validation and decryption, in step 406h the command or commands are then used by an operator or the item dispensing unit 450 at the POS system 415 to distribute the desired item, such as a cup of coffee. As such, the user is able to save time without having to wait on line, and the coffee shop is able to increase efficiency by having the order pre-made and payment already processed.

Additionally, where the electronic device 410 is in communication with a printer 540, in step 406d the device CPU 430 may transfer the QR Code receipt to the printer 540 to output a printed copy of the QR Code receipt for a user to manually position in front of the POS system 415 sensor 455.

Further, where the POS system 415 is in communication with a printer 545, in step 406d the POS CPU 485 may transfer the QR Code receipt to the printer 545 to output a printed copy or sticker for an operator to place on the item corresponding to the QR Code receipt. The POS system 415 operator may fix the sticker to the cup of coffee ordered by the user. Upon arrival, the user captures the QR Code receipt on the sticker via the sensor 442. Software in the device CPU 430 compares the sticker to the stored QR Code receipt to signal whether the sticker is a match to the user's purchase and notifies the user. The device CPU 430 then sends a signal to the web resource 420 to confirm pickup, and the web resource 420 may then send a signal to the POS system 415 to confirm distribution.

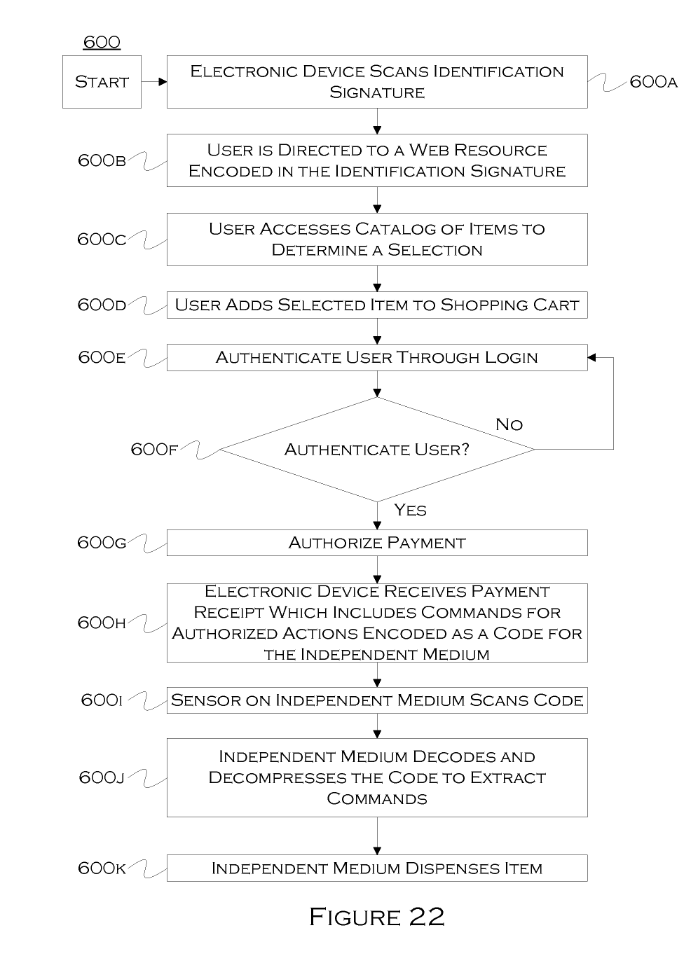

Referring now to FIG. 22, there is illustrated a transaction system 600. In step 600a an electronic device scans an identification signature at an independent medium. In step 600b the user is directed to a web resource encoded in the identification signature. In step 600c the user accesses a catalog of items on the web resource to determine a selection. In step 600d the user adds a selected item to a shopping cart. In step 600e software in the web resource authenticates the user through a login process. In step 600f, the web resource authenticates the user. In the event the authentication fails, step 600e is repeated. In the event authentication is valid, payment is authorized in step 600g and the web resource creates a payment receipt. In step 600h the electronic device receives the payment receipt which includes commands for authorized actions encoded as a code for the independent medium. In step 600i a sensor on the independent medium scans the code. In step 600j the independent medium decodes and decompresses the code to extract the commands. In step 600k the independent medium dispenses the selected item in accordance with the commands.

As such, the illustrative embodiments of the invention disclosed herein provide multiple transaction system embodiments to use commands on a code receipt for an electronic device to obtain a desired item. One illustrative embodiment eliminates the need for an internet enabled independent medium, thereby making independent medium installation possible in remote areas where internet connectivity is either poor, unavailable, or in applications where internet connectivity is not feasible. Additionally, illustrative embodiments of the transaction systems may operate without the presence of cellular towers to enable use anywhere including cities, deserts, and mountains. The encryption and security options described herein further provide protection for users and customers since the independent mediums do not store personal data that may be hacked are stolen. The uniqueness of each QR Code receipt provides benefits to owners of the independent mediums since each QR Code receipt only applies to one individual transaction further adding another layer of security. Where a POS system is utilized in an illustrative embodiment, retailers improve efficiency in customer service and delivery of products.

From the foregoing and as mentioned above, it will be observed that numerous variations and modifications may be effected without departing from the spirit and scope of the novel concept of the invention. It is to be understood that no limitation with respect to the specific methods and apparatus illustrated herein is intended or inferred.

What is claimed is:

1. An autonomous item dispensary for dispensing items comprising:
an identification signature;
one or more digitally identifiable items associated with the identification signature; and
a processor in communication with a code receiver and an item dispensing unit, the processor configured to handle a code receipt received by the code receiver to verify completion of a purchase transaction relating to one or more of the digitally identifiable items and direct the item dispensing unit to deliver one or more purchased items identified by the code receipt.

2. The autonomous item dispensary of claim 1, wherein the code receiver receives the code receipt from a user electronic device.

3. The autonomous item dispensary of claim 2, wherein the user electronic device receives the code receipt from a remote server.

4. The autonomous item dispensary of claim 1, wherein the code receiver captures an image of the code receipt.

5. The autonomous item dispensary of claim 1, wherein the code receiver captures an image of the code receipt displayed on a user electronic device.

6. The autonomous item dispensary of claim 1, wherein the code receipt further comprises data including the identification signature and a purchase time stamp encrypted with a variable encryption cipher key.

7. The autonomous item dispensary of claim 6, wherein the code receiver is configured to:
decrypt the variable encryption cipher key; and
obtain a current time stamp for comparing with the purchase time stamp.

8. The autonomous item dispensary of claim 1, wherein the code receipt further comprises operating instructions to facilitate the delivery of the one or more purchased items identified by the code receipt.

9. The autonomous item dispensary of claim 1, wherein the processor is further configured to send a record of the purchase transactions relating to the one or more digitally identifiable items to a remote server.

10. The autonomous item dispensary of claim 1, further comprising a display configured to display information relating to the digitally identifiable items.

11. The autonomous item dispensary of claim 10, wherein the information prompts a user to interact with the autonomous item dispensary.

12. The autonomous item dispensary of claim 1, further comprising a sensor configured to capture a user interaction with the autonomous item dispensary.

13. A computer-implemented method comprising:
electronically receiving a code receipt including verification of a purchase transaction and identification of a digitally identifiable item associated with an autonomous item dispensary identification signature;
validating the code receipt via an autonomous item dispensary; and
dispensing the digitally identifiable item from the autonomous item dispensary.

14. The method of claim 13, wherein the receiving further comprises capturing an image of the code receipt via an autonomous item dispensary sensor.

15. The method of claim 14, wherein the code receipt is captured from a user device display.

16. A computer readable storage medium storing instructions that, when executed by a processor of an autonomous item dispensary, causes the processor to perform a method comprising:
electronically receiving a code receipt including verification of a purchase transaction and identification of a digitally identifiable item associated with an autonomous item dispensary identification signature;
validating the code receipt via the autonomous item dispensary; and
dispensing the digitally identifiable item from the autonomous item dispensary.

17. The computer readable storage medium of claim 16, the receiving further comprising capturing an image of the code receipt via an autonomous item dispensary sensor.

18. The computer readable storage medium of claim 17, wherein the code receipt is captured from a user electronic device display.
